(19) United States
(12) Patent Application Publication
(10) Pub. No.: US 2009/0241423 A1
(43) Pub. Date: Oct. 1, 2009

(54) OVERHEAD GARAGE DOOR HINGING TOP BRACKET

(75) Inventor: Dean Benoy, River Falls, WI (US)

Correspondence Address: MERCHANT & GOULD PC, P.O. BOX 2903, MINNEAPOLIS, MN, 55402-0903, US

(73) Assignee: Designer Doors, Inc., River Falls, WI (US)

(21) Appl. No.: 12/413,029

(22) Filed: Mar. 27, 2009

Related U.S. Application Data
(60) Provisional application No. 61/072,163, filed on Mar. 27, 2008.

(51) Int. Cl. E05D 15/38; E06B 3/00

(52) U.S. Cl. 49/197; 49/506

(57) ABSTRACT

The present disclosure provides an improved sectional roll-up door system and related method. In one embodiment, the system includes hardware that enables a sectional roll-up door to be installed in situations wherein the door-to-ceiling clearance is very limited. In another embodiment of the present disclosure, the system includes hardware that minimizes stress and wear on a door installed in a multi-track system. A method of installing a sectional door in an area with limited ceiling clearance is also provided.

### RELATED APPLICATIONS

This application claims priority from Provisional Application Ser. No. 61/072,163, entitled “OVERHEAD GARAGE DOOR HINGING TOP BRACKET,” filed Mar. 27, 2008, and which is incorporated herein by reference.

### TECHNICAL FIELD

The present disclosure relates to a sectional roll-up door system and method.

### BACKGROUND

Sectional roll-up doors, commonly referred to as garage doors, are known. For some applications where the vertical space between the top of the door and the ceiling is limited, dual track doors are used. Dual track doors allow the uppermost section of the roll-up door to be positioned as close to the same vertical position as the vertical section of track that supports the door when the door is in the opened position. For an example of a dual track sectional roll-up door see U.S. Pat. No. 6,089,304 to Mullet et al. In most dual or multi-track sectional roll-up door systems, only the uppermost door panel rides in the secondary track. This configuration results in an undesirable pinch point between the bottom edge of the uppermost door section and the top edge of the adjacent door section. The above-described pinch point is illustrated in FIG. 2, which is a figure of a prior art system. The present disclosure provides a system that avoids this issue, as well as others. The present disclosure provides a more effective sectional roll-up door system and related method.

### SUMMARY

The present disclosure provides an improved sectional roll-up door system and related method. In one embodiment, the system includes hardware that enables a sectional roll-up door to be installed in applications wherein the door-to-ceiling clearance is very limited. In another embodiment of the present disclosure, the system includes hardware that minimizes stress and wear on a door installed in a multi-track system. A method of installing a sectional door in an area with limited ceiling clearance is also provided.

### BRIEF DESCRIPTION OF THE DRAWINGS

FIG. 1 is a side view of a portion of a prior art sectional door system with the door in the closed position with dashed lines showing the door in a slightly open position;

FIG. 2 is a side view of a portion of the sectional door of FIG. 1 where the door is at least partially open;

FIG. 3 is a side view of a portion of a sectional door system according to the present disclosure with the door in the closed position;

FIG. 4 is a side view of a portion of the sectional door of FIG. 3 where the door is substantially open;

FIG. 5 is a side view of a portion of the sectional door of FIG. 3 where the door is slightly open;

FIG. 6 is a perspective view of a mounting bracket of the sectional door of FIG. 3;

FIG. 7 is a side view of the mounting bracket of FIG. 6;

FIG. 8a is a front view of a portion of the mounting bracket of FIG. 6;

FIG. 8b is a side view of a portion of the mounting bracket of FIG. 6;

FIG. 9a is a front view of a portion of the mounting bracket of FIG. 6;

FIG. 9b is a side view of a portion of the mounting bracket of FIG. 6;

FIG. 10a is a side view of a portion of a prior art single track sectional door system showing the door in the closed position and in a slightly open position; and

FIG. 10a is a side view of a portion of a single track sectional door system according to the present disclosure showing the door in the closed position and in a slightly open position.

### DETAILED DESCRIPTION

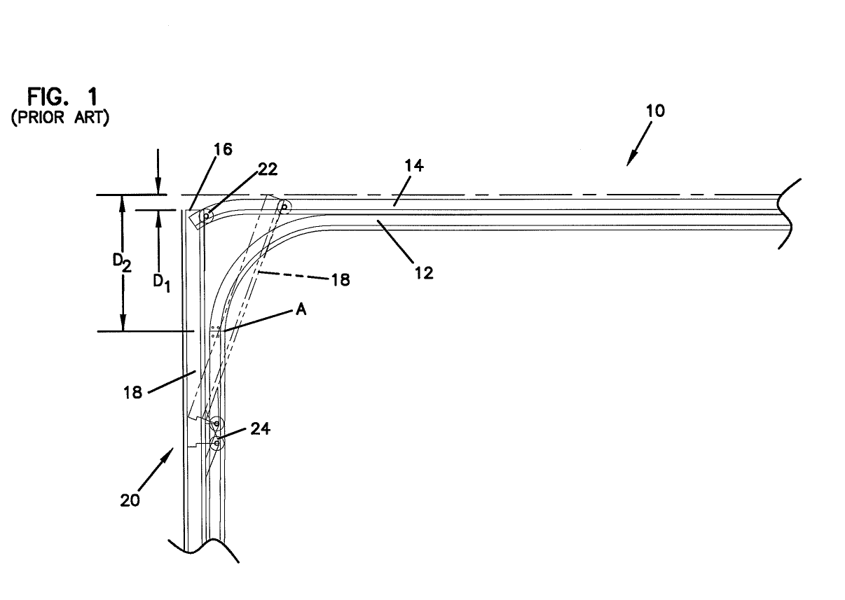

Referring to FIG. 1, a side view of a prior art dual track system 10 is shown. The system includes a multi-section/multi-panel door 20 engaged with an L-shaped lower track 12 and a horizontal upper track 14. The system is configured for application where the clearance between the top of the door opening and the ceiling of the garage is low. In a one track system the upper edge of the uppermost section/panel of the door is typically located below position A, which is where the L-shaped track begins to transition from being vertical to horizontal. In a one track system the clearance between the ceiling and the top of the door needs to be greater than the vertical distance between point A and the upper edge of the horizontal track 14, which is referenced as D₂. In the dual track system the distance D₁ between the upper edge 16 of the uppermost section 18 of the door 20 and the upper edge of the track is much less than in a single track system. Therefore, the dual track system is especially desirable where the vertical distance between the door opening and the ceiling is small.

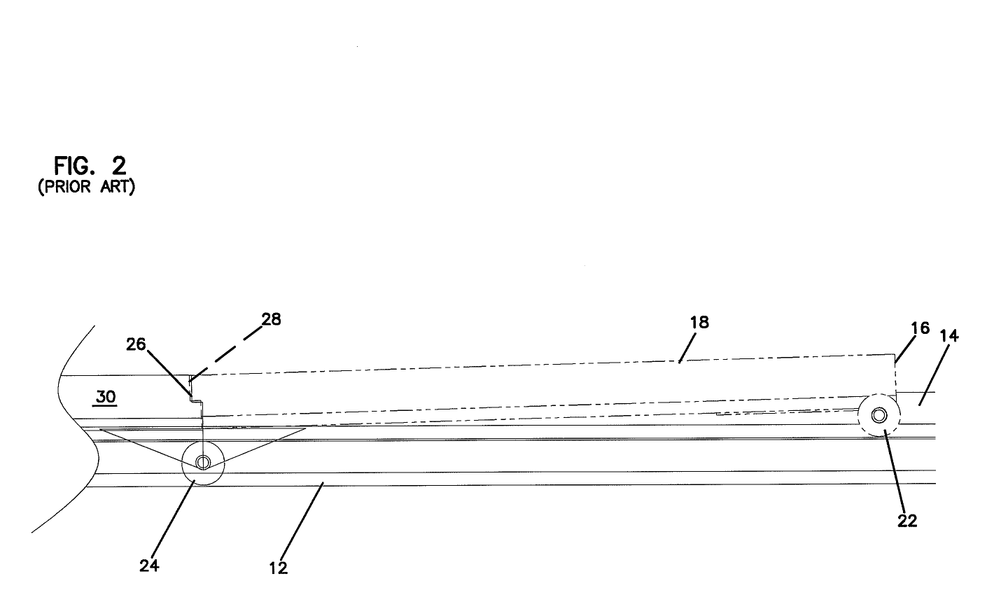

Referring to FIGS. 1 and 2, the prior art dual track system is described in greater detail. In the dual track system 10, the upper track 14 engages rollers 22 attached near the upper edge 16 of the uppermost panel 18 of the door 20. The rollers 24, attached to other areas of the door 20, engage the L-shaped track 12. In the prior art systems this configuration often results in a pinch point or stress point between the lower edge 26 of the uppermost panel 18 and the upper edge 28 of the adjacent panel 30. This pinch point can cause the door 20 to fail in use or prematurely wear at that location. In addition, the configuration also results in the portions of the upper edge 16 of the uppermost panel 18 extending above the uppermost portions of the horizontal track 14 in use. For example, see FIG. 1 showing the upper edge 16 extending above the horizontal track 14 when the door 20 is in the slightly open position.

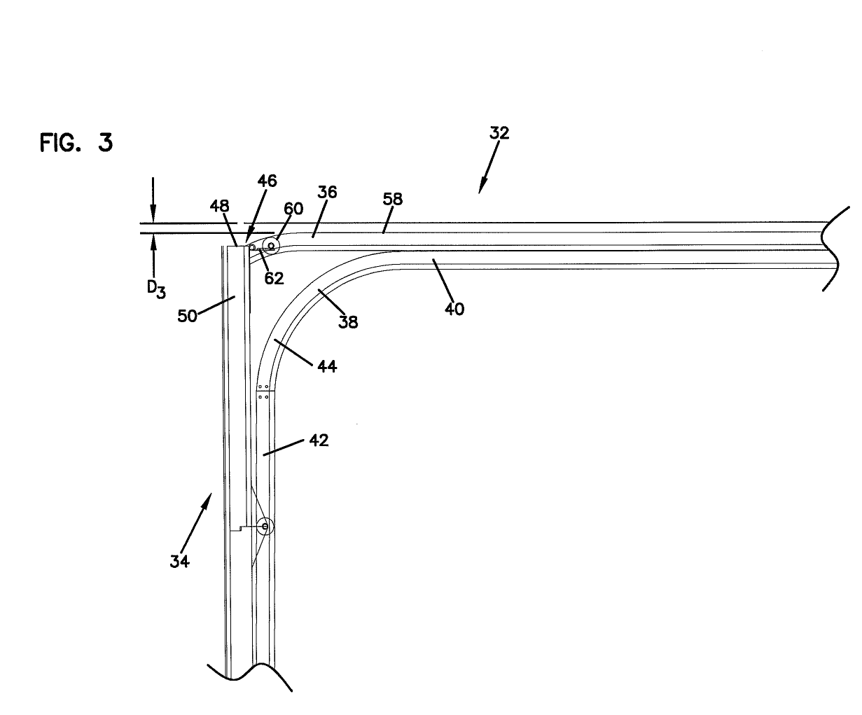

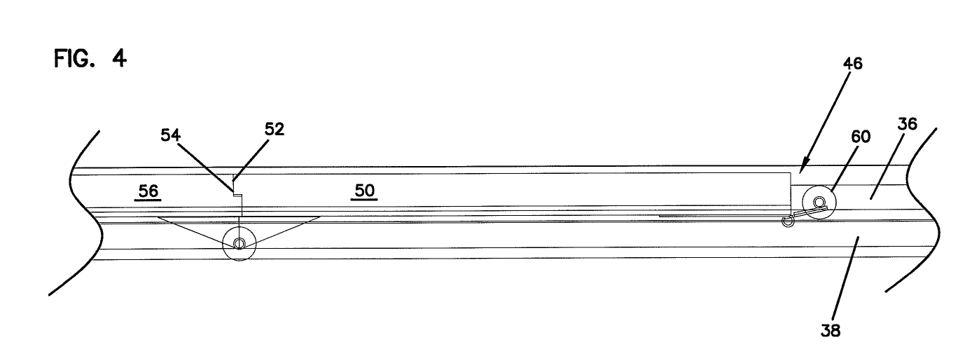

Referring to FIGS. 3-5, an embodiment of the multi-sectional door system of the present disclosure is described in greater detail. The multi-sectional door system 32 includes a sectional door 34, an upper track 36, and a lower track 38. The upper track 36 is generally horizontal with a curved portion adjacent the door opening. The lower track 38 is generally L-shaped with a horizontal portion 40, a vertical portion 42, and a transitional curved portion 44. A roller mechanism 46 is shown attached near the upper edge 48 of the uppermost door panel 50. When the door is at least partially opened as shown in FIG. 4, the lower edge 52 of the uppermost panel 50 does not pinch the upper edge 54 of the adjacent panel 56.

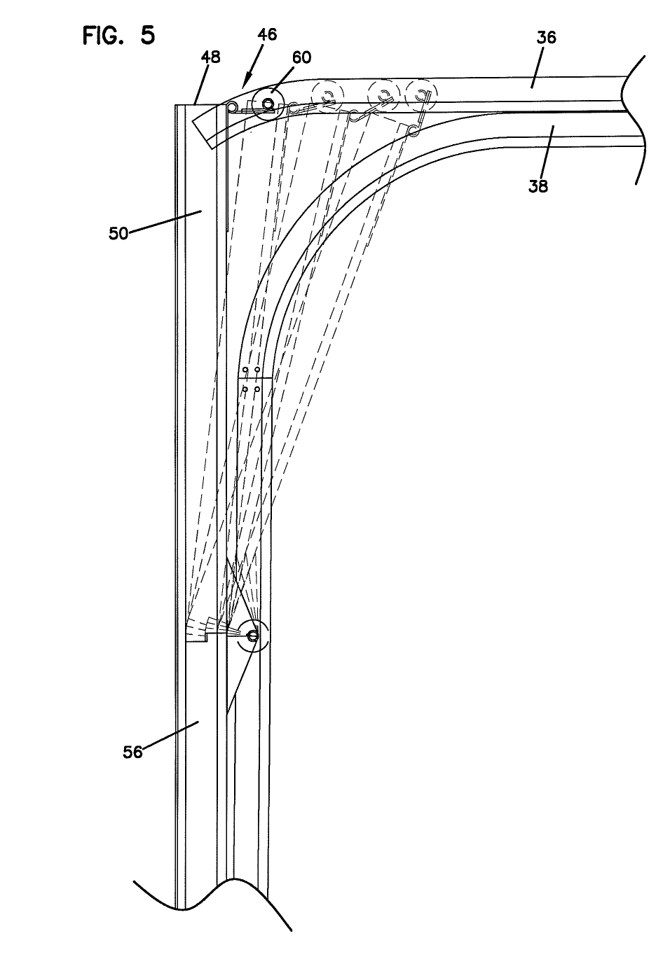

In the depicted embodiment the upper edge 48 of the uppermost panel 50 does not extend above the upper track 36 when the sectional door 34 is in use. See FIG. 5. Therefore, the clearance D₃ between the upper edge 58 of the upper track 36 and the ceiling can be minimized. In some embodiments the clearance D₃ can be less than 12 inches. In yet other embodiments the clearance D₃ is less than three inches. In other embodiments the clearance D₃ is less than one inch. It should be appreciated that the door system of the depicted embodiment can also be installed in areas where vertical clearance is not an issue.

Still referring to FIGS. 3-5, the roller mechanism 46 is described in greater detail. In the depicted embodiment the roller mechanism 46 includes a roller 60 pivotally attached to a swing arm 62. In the depicted embodiment, the swing arm 62 is hinged to the inside surface of the uppermost panel 50 adjacent the upper edge 48 of the panel 50. The configuration and arrangement of the roller mechanism 46 allows the uppermost panel 50 to be generally in the same plane as the adjacent panel 56 when the door is open (see FIG. 4). Moreover, the configuration and arrangement of the roller mechanism 46 allows the upper edge 48 of the uppermost panel 50 to maintain a low position relative to the upper track 36 when the sectional door 34 is being opened and closed (see FIG. 5).

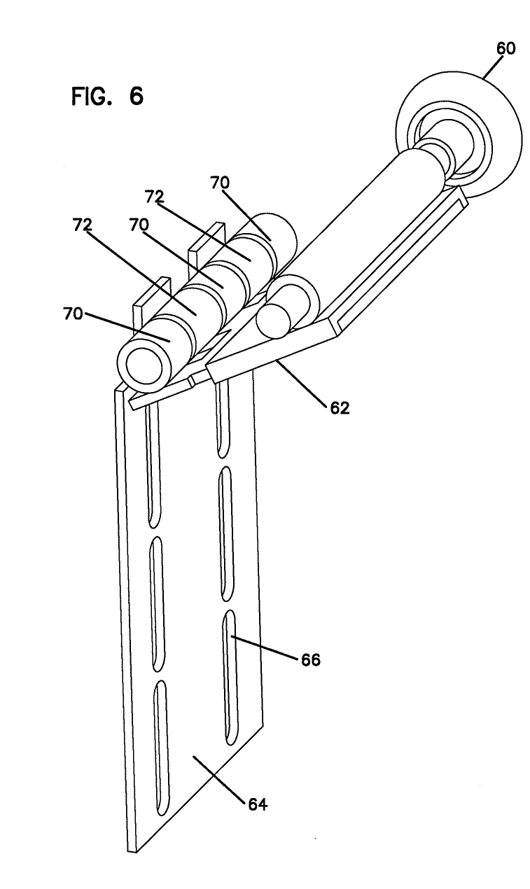

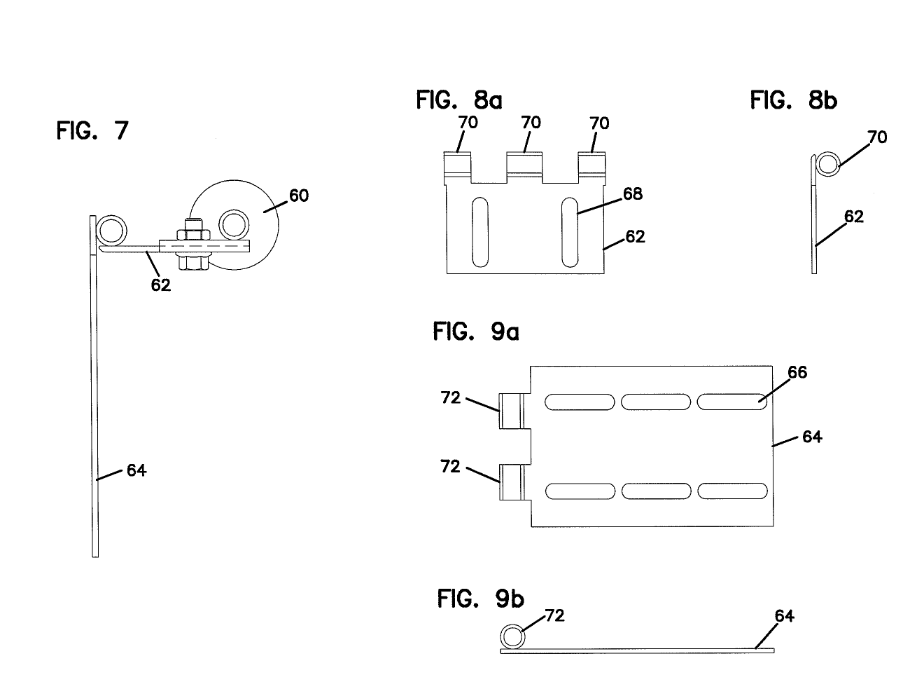

Referring to FIGS. 6-9b, the components of an embodiment of the roller mechanism 46 are described in greater detail. In the depicted embodiment, the roller mechanism 46 includes a swing arm 62 that connects a roller 60 to a mounting flange 64. The mounting flange 64 and the swing arm 62 are connected to each other in a hinge arrangement. The hinge arrangement includes a pin that extends through nested and aligned tab portions 72 on the flange 64 and the swing arm 62. In the depicted embodiment flange 64 includes slotted apertures 66 configured to receive mounting fasteners that connect the flange 64 to the inside surface of the uppermost panel 50 of the sectional door 34. In the depicted embodiment the flange 64 is connected adjacent the upper edge of 48 of the uppermost panel 50. The slotted apertures 66 allow the exact location of the flange 64 relative to the panel 50 to be easily adjusted. Moreover, in the depicted embodiment a roller mechanism 46 is attached to each end of the uppermost panel of the sectional door 34. It should be appreciated that alternative configurations and arrangements are also possible.

In the depicted embodiment, the swing arm 62 includes spaced apart tabs 70 that are configured to be hinged with the flange 64. The swing arm also includes slotted apertures 68 that are configured to receive fasteners that connect the rollers 60 to the swing arm 62 (see FIG. 7). In the depicted embodiment the swing arms 62 have a length that is greater than the radius of the roller 60. In some embodiments the length of the swing arm is between 1-12 inches. In the depicted embodiment the length of the swing arm 62 is greater than the diameter of the roller 60. It should be appreciated that many alternative configurations are also possible.

It should be appreciated that the roller mechanism 46 can be used contexts other than in a dual track door system. For example, embodiments of the roller mechanism can be used in single track systems. See, for example, FIGS. 10a and 10b. FIG. 10a shows a single track system with the prior art roller arrangement. When the door is partially opened a portion of the uppermost door panel 80 extends substantially above the track 82, which necessitates that the clearance between the ceiling 84 and the track 82 be relatively large (e.g., 15 inches). The roller mechanism 46 in a single track system enables the door panel(s) to be raised and lowered smoothly without having portions of the panel(s) extend substantially above the roller track when the door is being opened or closed. FIG. 10b illustrates that when the upper panel 90 of the door is in a closed position, the swing arm 92 of the roller mechanism 46 is extended away from the upper panel. When the door is in a partially opened position, the swing arm pivots towards the upper panel 90, which allows the upper panel to move more rearward and less upward when the door is being opened. Consequently, the clearance between the ceiling 96 and the upper track 94 can be substantially less than in the system of FIG. 10a. Referring to FIG. 10b, it should be appreciated that the roller mechanism can be particularly advantageous in single track systems where the transition section of the track, which is between the vertical and horizontal sections of track, is relatively small. In other words, the roller mechanism can be particularly advantageous in systems where the L-shaped track abruptly changes direction.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A mounting system for a sectional roll-up door system comprising:
a first track including a vertical portion and a horizontal portion;
a second track configured to be positioned above the vertical portion of the first track;
a first roller configured to ride in the second track;
an arm attached to the roller; and
a mounting flange pivotally connected to the arm, the mounting flange being configured to attached to a section of the roll-up door.

2. A roll-up door comprising:
a plurality of rectangular panels that are longer than they are wide, each panel including an upper longitudinal edge and a lower longitudinal edge, a first end, and a second end;
a first, generally L-shaped, track, wherein the L-shaped track is oriented to include a horizontal section and a vertical section, wherein the length of both the horizontal section and the vertical section is greater than the sum of the width of the plurality of panels, wherein the L-shaped track includes a curved transition section that connects the horizontal section with the vertical section;
a second, generally L-shaped, track, wherein the L-shaped track is oriented to include a horizontal section and a vertical section, wherein the length of both the horizontal section and the vertical section is greater than the sum of the width of the plurality of panels, wherein the L-shaped track includes a curved transition section that connects the horizontal section with the vertical section;
a first, generally horizontal, track positioned above and generally parallel to the first L-shaped track;
a second, generally horizontal, track positioned above and generally parallel to the second L-shaped track;
a first roller assembly connecting the uppermost panel of the plurality of rectangular panels to the first, generally horizontal, track, the first roller assembly including a first mounting flange connected adjacent the first end of the upper longitudinal edge of the uppermost panel;
a first arm that is pivotally connected to the first mounting flange, the first arm being connected to a first roller, the first roller being engaged with the first, generally horizontal, track;
a second roller assembly connecting the uppermost panel of the plurality of rectangular panels to the first, generally horizontal, track, the second roller assembly including a second mounting flange connected adjacent the second end of the upper longitudinal edge of the uppermost panel;
a second arm that is pivotally connected to the first mounting flange, the second arm being connected to a second roller, the second roller being engaged with the second, generally horizontal, track;
a third roller assembly connecting the uppermost panel of the plurality of rectangular panels to the first, generally L-shaped, track, the third roller assembly including a first mounting member connected adjacent the first end of the lower longitudinal edge of the uppermost panel, the first mounting member being connected to a third roller, the third roller being engaged with the first, generally L-shaped, track;
a fourth roller assembly connecting the uppermost panel of the plurality of rectangular panels to the second, generally L-shaped, track, the fourth roller assembly including a second mounting member connected adjacent the second end of the lower longitudinal edge of the uppermost panel, the second mounting member being connected to a fourth roller, the fourth roller being engaged with the first, generally L-shaped, track;
wherein the first and second mounting flanges are connected to the inside surface of the uppermost panel;
wherein the first arms and second arms of the first and second roller assemblies are greater than the diameter of the first and second rollers;
wherein the length of the first and second arms is between 1-12 inches long;
wherein an end portion of the first and second generally horizontal tracks are curved;
wherein the lengths of the first and second, generally horizontal, tracks are both greater than the sum of the width of the plurality of panels; and
wherein the vertical distance between the upper longitudinal edge of the uppermost panel and the top most portion of the generally horizontal tracks is less than 12 inches.

3. A method of installing a roll-up door comprising:
connecting a roller to an uppermost panel of a roll-up door such that an axis of the roller extends a distance away from the surface of the panel and can pivot relative to the panel; and
positioning the roller in the uppermost track of two horizontally arranged tracks.

4. The method of claim 3, wherein the roller is connected to the uppermost panel such that no portion of the uppermost panel extends above an upper track member during the opening or closing of the roll-up door.

5. The method of claim 3, wherein the roller is connected to the uppermost panel such that the uppermost panel is substantially aligned with an adjacent panel when the door is in an open position.

6. The method of claim 5, wherein the angle between the surface of the uppermost panel and the adjacent panel in the open position is between 170-180 degrees.
